(19) United States
(12) Patent Application Publication
(10) Pub. No.: US 2023/0258510 A1
(43) Pub. Date: Aug. 17, 2023

(54) WEARABLE ARTICLE WITH FLEXIBLE INDUCTIVE PRESSURE SENSOR

(71) Applicant: Liquid Wire, LLC, Portland, OR (US)

(72) Inventors: Edward Martin GODSHALK, Newberg, OR (US); Trevor Antonio RIVERA, Portland, OR (US); Michael Adventure HOPKINS, Portland, OR (US)

(73) Assignee: Liquid Wire, LLC, Portland, OR (US)

(21) Appl. No.: 18/043,748

(22) PCT Filed: Sep. 3, 2021
(86) PCT No.: PCT/US21/71374

§ 371 Date: Mar. 2, 2023

Related U.S. Application Data
(60) Provisional application No. 62/706,722, filed on Sep. 4, 2020.

(51) Int. Cl. G01L 1/14; H01B 1/02; G01L 1/26; G06F 3/01

(52) U.S. Cl. CPC G01L 1/14; H01B 1/02; G01L 1/26; G06F 3/014

(57) ABSTRACT

A flexible inductive pressure sensor, system, and method include an inductor configured to deform in multiple dimensions while maintaining inductive properties. A conductor is spaced apart from the inductor by a spacer positioned between the inductor and the conductor. The inductor has an inductance that varies based on an instantaneous distance between the inductor and the conductor. A capacitor is electrically coupled to the inductor and having a capacitance, wherein the inductor and the capacitor form a resonant circuit based on the inductance of the inductor and the capacitance of the capacitor. The resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

### CLAIM OF PRIORITY

This patent application claims the benefit of priority to U.S. Provisional Application Ser. No. 62/706,722, filed Sep. 4, 2020, which is incorporated by reference herein in its entirety.

### TECHNICAL FIELD

The subject matter disclosed herein generally relates to a wearable article having a flexible inductive pressure sensor, system, and method.

### BACKGROUND

Pressure sensors, also known as force collectors, conventionally measure a relative amount of pressure or force that is placed on a surface or object and output a signal, e.g., an electrical signal, indicative of the pressure or force as detected. Pressure sensors may be formatted according to a variety of configurations based on the circumstances of the use of the pressure sensor.

Such pressure sensors may typically incorporate common electronic components dependent on the type of pressure sensor.

### BRIEF DESCRIPTION OF THE DRAWINGS

Some embodiments are illustrated by way of example and not limitation in the figures of the accompanying drawings.

FIG. 1 is an image of a flexible inductive pressure sensor, in an example embodiment.

FIG. 2 is a circuit diagram of a flexible inductive pressure sensor, in an example embodiment.

FIGS. 3A and 3B are an illustration of the change in the configuration of an inductor and conductor as force is placed on one or both of the inductor and conductor, in an example embodiment.

FIG. 4 is a response graph of the inductance of an inductor based on the change in distance between the inductor and a conductor, in an example embodiment.

FIGS. 5A and 5B are illustrations of a voltage response of an RLC circuit of a circuit diagram, in an example embodiment.

FIG. 6 is a profile view of an inductor, in an example embodiment.

FIG. 7 is a block diagram of the flexible inductive pressure sensor incorporated into a system, in an example embodiment.

FIG. 8 is illustration of a control glove that incorporates multiple flexible inductive pressure sensors, in an example embodiment.

### DETAILED DESCRIPTION

Example methods and systems are directed to a flexible inductive pressure sensor, system, and method. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

While certain electronic components typically have some inherent flexibility, that flexibility is typically constrained both in the amount the components can flex, their resilience in flexing, and the number of times the electronic components can flex before the electronic components deteriorate or break. Consequently, the utility of such pressure sensors in various environments may be limited, either by reliability or longevity or by the ability, to function at all. For instance, incorporating pressure sensors into body worn sensors or wearable articles may be challenging because such environments may involve repetitious and/or unusual flexing or bending of the pressure sensor.

A wearable article has been developed that incorporates a flexible inductive pressure sensor. The flexible inductive pressure sensor incorporates a highly flexible and resilient inductor paired with a conductor separated by a spacer, such as a spring or material with a spring constant. The conductor, such as a copper sheet or other conductive material, changes the inductance of the inductor owing to pressure placed on one or the other of the conductor and the inductor changing the distance between the inductor and conductor. Because of the flexibility of the inductor, conductor, and other components of the pressure sensor, the flexible inductive pressure sensor is suitable for body worn sensors or inclusion in wearable articles, such as gloves, in which the pressure sensor may provide output sufficiently sensitive to control remote devices.

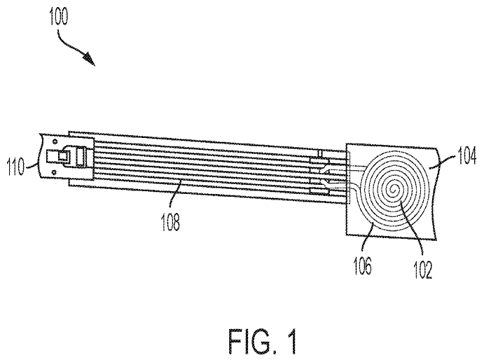

FIG. 1 is an image of a flexible inductive pressure sensor 100, in an example embodiment. The flexible inductive pressure sensor 100 includes an inductor 102, a conductor 104 separated from the inductor 102 by a spacer 106. The spacer 106 is resiliently deformable or has the characteristics of a spring to allow the spacer 106 to compress when force is applied to one or both of the inductor 102 and the conductor 104, thereby decreasing the distance between the inductor 102 and the conductor 104 and changing the inductance of the inductor 102. The flexible inductive pressure sensor 100 further includes a flexible cable 108, such as a flexible ribbon cable, which electrically couples the inductor 102 to a connector 110. The connector 110 is configured to couple the flexible inductive pressure sensor 100 to electronic components which may receive output signals from the flexible inductive pressure sensor 100 that may vary, e.g., voltage, current, or both, based on the changes in the inductance of the inductor 102 based on the distance between the inductor 102 and the conductor 104.

While the flexible inductive pressure sensor 100 is illustrated with particular components beyond the inductor 102, conductor 104, and spacer 106, it is to be recognized and understood that the configuration of the additional components may be adapted to the circumstances in which the flexible inductive pressure sensor 100 is being utilized. Thus, while the configuration illustrated in FIG. 1 may be particularly adapted for use in or along the fingers of a glove, as will be illustrated in detail herein, alternative configurations of the flexible inductive pressure sensor 100 may be suitable for other circumstances. For instance, uses of the flexible inductive pressures sensor 100 that are incorporated in environments that do not involve general flexing outside of the area of the inductor 102 itself may omit or significantly shorten the flexible cable 108. Similarly, the connector 110 may be selected based on components to which the flexible inductive pressure sensor 100 is coupled.

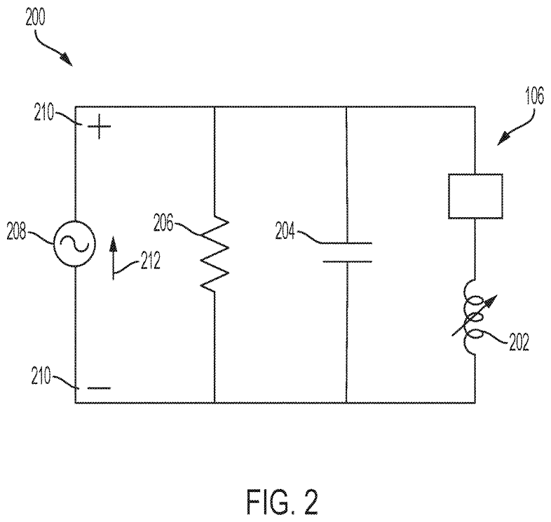

FIG. 2 is a circuit diagram 200 of the flexible inductive pressure sensor 100, in an example embodiment. The inductor 102 and the conductor 104 (FIG. 1) together combine to create the electrical equivalent of a variable inductor 202. The variable inductor 202 is coupled in series with inherent capacitance or inductance that may be introduced by the spacer 106. In various examples, the inherent capacitance or inductance of the spacer 106 may be negligible, e.g., where the spacer 106 is a strong dielectric material or a mechanical spring. Alternatively, the spacer 106 may include or be formed from a material that introduces non-negligible capacitance or inductance into the circuit. The circuit diagram 200 further includes a capacitor 204 in parallel with and electrically coupled to the variable inductor 202. In various examples, the capacitor 204 is positioned in or is a component of the connector 110. Additionally or alternatively, the capacitor 204 may be omitted in favor of or supplemented by the inherent capacitance of the spacer 106. The circuit diagram 200 further includes system impedance 206 introduced by various components of the flexible inductive pressure sensor 100, such as the flexible cable 108, the connector 110, and electrical connections with the inductor 102 and the capacitor 204. The system impedance 206 may optionally further include a discrete resistor or impedance component. The variable inductor 202, the capacitor 204, and the system impedance 206 combine to form an RLC or resonant circuit.

In various examples, the circuit diagram 200 includes a power source 208. The power source 208 may be a component of the flexible inductive pressure sensor 100 or may be an external component of the flexible inductive pressure sensor 100 and may be operatively coupled to the flexible inductive pressure sensor 100 by way of the connector 110. In various examples, the power source 208 is an alternating current (AC) power source though the principles disclosed herein apply as well in examples where the power source 208 is a direct current (DC) power source.

As is known in the art, the resonant frequency of an RLC circuit varies based on changes in resistance, capacitance, and inductance. In the instant circuit diagram 200, the resistance and capacitance are substantially constant and/or changes in resistance and capacitance is negligible, resulting in changes to the resonant frequency of the RLC circuit depending on changes in the variable inductor 202. As disclosed herein, changes in the variable inductor 202 stern in substantial part from a change in distance between the inductor 102 and the conductor 104.

It is to be recognized and understood that the principles disclosed herein with respect to the circuit diagram 200 are applicable across a wide voltage and current range dependent on the electrical properties of the variable inductor 202, the capacitor 204, the spacer 106, and the system impedance 206. Consequently, the input voltage 210 and input current 212 from the power source 208 may be selected over any suitable range. In various examples, the input voltage 210 ranges from millivolts to tens of volts or more while the input current 212 ranges from microamperes to amperes; though values above and below those ranges may be suitable in other circumstances. Where the power source 208 is an AC power source, the output frequency may be up to the gigahertz range but may be selected based on the resonant frequency of the circuit diagram 200 based on a quiescent inductance of the variable inductor 202, e.g., an inductance when little or no force is placed on the inductor 102 and the conductor 104. In an example implementation of the flexible inductive pressure sensor 100, the quiescent inductance of the variable inductor 202 is eight hundred sixty (860) nanohenrys, the capacitor 204 is a 0.16 nanofarad capacitor, and the system impedance 206 is 12.1 ohms. In such an example, the resonant frequency is approximately 13.4 megahertz.

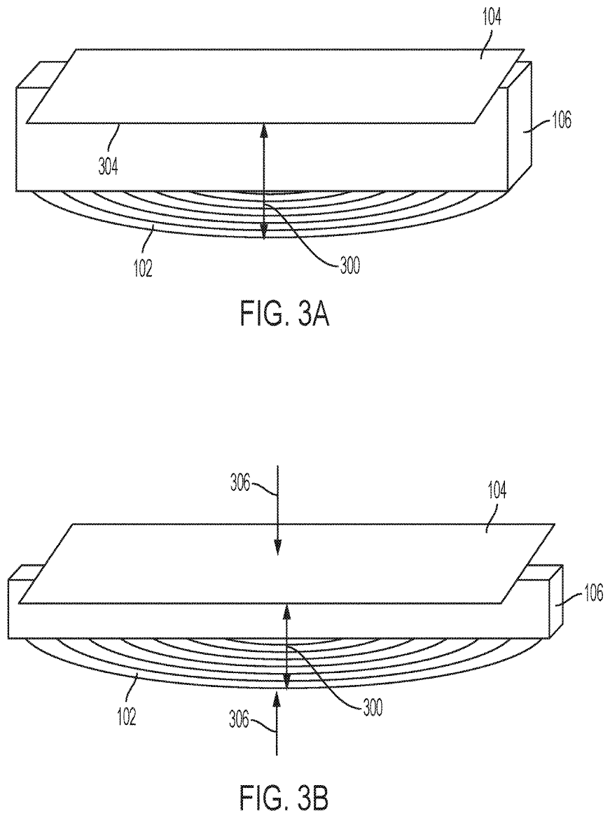

FIGS. 3A and 3B are an illustration of the change in the configuration of the inductor 102 and conductor 104 as force is placed on one or both of the inductor 102 and conductor 104, in an example embodiment. In the illustrated example, the inductor 102 is nine turns of conductive gel having a diameter of approximately twenty (20) millimeters. In the illustrated example, the conductor 104 is a square copper sheet approximately twenty (20) percent larger on each side than the diameter of the inductor 102, though it is to be recognized and understood that various relative sizes of the conductor 104 may be utilized as desired. In various examples, the conductor may be any size sufficiently large to impede an electromagnetic field generated by the inductor 102 and shield the inductor 102 from other environmental factors, including by being smaller on each side than the diameter of the inductor 102. Moreover, the conductor 104 may be irregular shapes.

It is to be recognized and understood that the conductor 104 may be formed of any conductive material, including a conductive fabric. For instance, the conductor 104 may be a woven fabric with metal coated yarns. In one example, the conductor may be a conductive silver tape having silver woven nylon ripstock fabric with C2 anti-corrosion coating, a high-tack, conductive adhesive system, and the following properties: surface resisitivity of less than 0.5 Ohms according to the ASTM F390 modified test method; volume resistance of approximately 0.20 Ohms-centimeter according to the LP 3007 test method; low temperature application of four (4) degrees Celsius; abrasion resistance of no change in surface resisitivity and no fabric degradation after more than 800,000 wear cycles; shrinkage of less than four (4) percent at 180 degrees Celsius; peel strength per the ASTM D3330 test method of 45.80 ounces per inch at one (1) hour dwell time and 47.47 ounces per inch at twenty-four (24) hours dwell time. In another example, the conductor 104 may be a conductive nickel silver nylon tape, including a silver metalized ripstop nylon topcoated with nickel and a conductive acrylic pressure sensitive adhesive having the following properties: total thickness of 0.01520 millimeters; low temperature application of four (4) degrees Celsius; a volume resistance of 1.87 Ohms-centimeters per the ASTM-D-2739 standard; a high temperature resistance of −46 degrees Celsius to two hundred and five degrees (205) degrees Celsius; peel strength per the ASTM D3330 test method of 71.8 ounces per inch width.

In an example, the spacer 106 is a dielectric foam having a thickness in a relaxed state of approximately five (5) millimeters, which corresponds to the distance 300 between a major surface 302 of the inductor 102 and a major surface 304 of the conductor 104 that faces the major surface 302 of the inductor, as shown in FIG. 3A. In various examples, the spacer 106 is an adhesive-backed foam sheet having a twenty-five (25) percent compression stress/strain characteristic from about forty-eight (48) kPa to about one hundred ten (110) kPa and, in an example, about seventy (70) kPa according to the ISO 3386/1 testing standard. In such examples, the spacer 106 may have a thickness from about 0.635 centimeters (one-quarter inch) to about 1.27 centimeters (one-half inch). The spring constant may be adjusted to suit the intended application by increasing or decreasing the density of the spacer 106 while the length of the spring may be adjusted to suit the intended application by increasing or decreasing the thickness of the spacer 106.

Consequently, the pliability of the components of the flexible pressure sensor 100 may combine to make the flexible pressure sensor highly conformable and moldable (e.g., a thermoforming inductor, foam, and/or tape) after lamination into the overall sensor assembly) which may provide for a contoured flexible pressure sensor 100 assembly that may readily receive or conform to, e.g., a portion of the wearer's body, such as a finger, as shown herein. The sensor layup of the flexible pressure sensor 100 may also exhibit excellent wearability and comfort as a result of enhanced compliance and pliability. It is emphasized that these parameters are for illustration only and that one of ordinary skill in the art may adapt various parameters as needed to align with the circumstances in which the pressure sensor 100 is to be used.

In FIG. 3B, force 306 is placed on the inductor 102 and conductor 104, e.g., because the pressure sensor 100 is pressed against an object. As a result of the force 306, the spacer 106 compresses to a compressed state, reducing the thickness of the spacer 106 and decreasing the distance 300 between the inductor 102 and the conductor 104. As will be illustrated herein, the reduction of the distance 300 reduces the inductance of the inductor 102 and consequently changes the resonant frequency of the RLC circuit of the circuit diagram 200. When the force 306 is removed the spacer 106 returns to the relaxed state and the distance 300 returns to the distance 300 as illustrated in FIG. 3A.

As illustrated, the major surface 302 of the inductor 102 is coplanar with the major surface 304 of the conductor 104 when the spacer 106 is in the relaxed state. Coplanar may be understood to mean that the major surfaces 302, 304 are substantially parallel with respect to one another and that opposing points on the major surface 302, 304 are substantially equidistant from one another. However, it is to be recognized and understood that as the force 306 is applied that one or both of the inductor 102 and the conductor 104 may tend to deform and that certain opposing points on the major surfaces 302, 304 may have varying distances with respect to one another. Consequently, the coplanar characteristics of the major surfaces 302, 304 may be assessed according to configurations in which the inductor 102 and conductor 104 are not deformed and in which the force 306 is not applied. The distance 300 may be assessed according to the closest any two opposing points on the major surfaces 302, 304 come to one another.

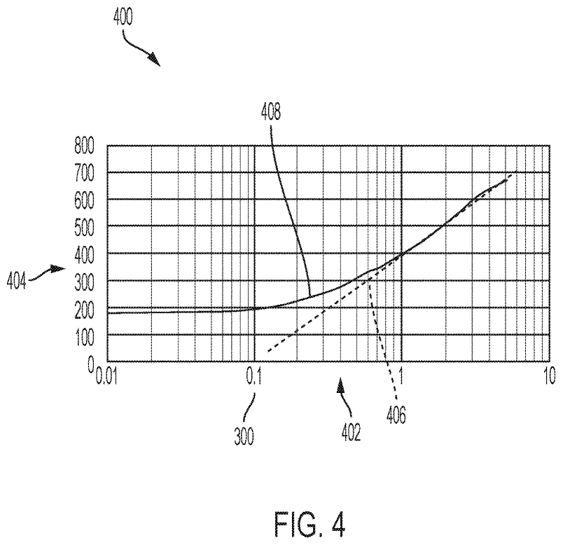

FIG. 4 is a response graph 400 of the inductance of the inductor 102 based on the change in distance 300 between the inductor 102 and the conductor 104, in an example embodiment. The response graph 400 includes distance 300 on the X-axis 402 and inductance of the variable inductor 202 on the Y-axis 404. The X-axis is a logarithmic scale. The response graph 400 includes a theoretical curve 406 and an empirical curve 408 reflecting the reality of physical limitations on the capacity of the spacer 106 used in the example of FIGS. 3A and 3B to compress and still change the inductance of the inductor 102. As can be seen, in the example embodiment, the inductance of the inductor 102 empirically decreases logarithmically as the distance 300 decreases until the distance 300 decreases to approximately one (1) millimeter.

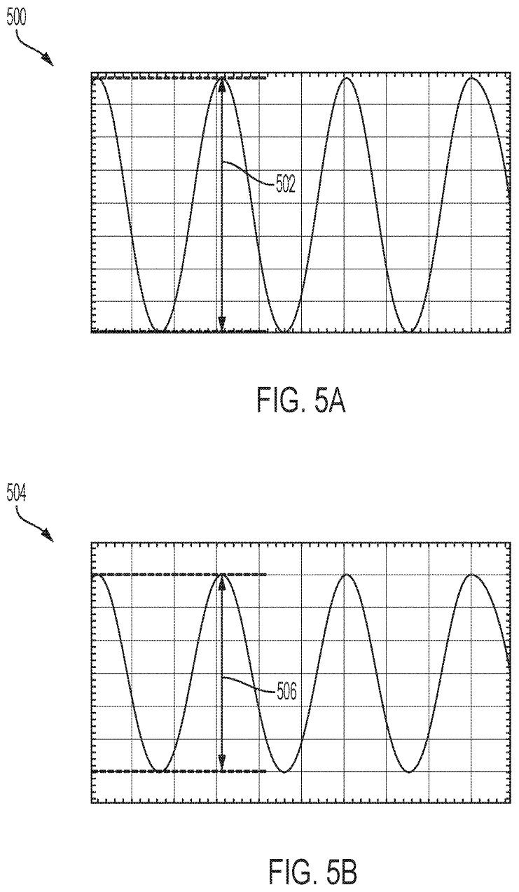

FIGS. 5A and 5B are illustrations of the voltage response of the RLC circuit of the circuit diagram 200, in an example embodiment. FIG. 5A reflects the voltage response 500 of the pressure sensor 100 in the configuration of FIG. 3A, in which the force 306 has not been applied and the spacer 106 is in the relaxed state. Where the power source 208 is outputting an AC signal at the quiescent resonant frequency of the RLC circuit of 13.4 megahertz, the voltage amplitude response 502 is 7.64 volts peak-to-peak.

FIG. 5B reflects the voltage response 504 of the pressure sensor 100 in the configuration of FIG. 3B, in which the force 306 has been applied and. the spacer 106 is a compressed state, reducing the distance 300 between the inductor 102 and the conductor 104. Consequently, the inductance of the variable inductor 202 and the resonant frequency of the RLC circuit has changed. As a result, the peak-to-peak voltage amplitude 506 has dropped to 6.64 volts. On the basis of the change in peak-to-peak voltage amplitude from 7.64 volts to 6.64 volts, the instantaneous inductance of the variable inductor 202 can be determined. The instantaneous inductance of the variable inductor 202 can be compared against the empirical curve 408 of the response graph 400 to determine the in distance 300 along the X-axis 402.

It is noted and emphasized that the values described with respect to FIGS. 4 and 5 are illustrative and not limiting. In addition to having different values based on different use modes, e.g., the actual distance 300 involved, the values themselves will change based on the electrical properties of the various components. Thus, the magnitude of the parameters for the inputs and detected or determined outputs may vary by orders of magnitude dependent on the circumstances of use. Furthermore, the parameters themselves are not limiting, and while, for instance, peak-to-peak voltage amplitude is discussed, it is to be recognized and understood than any suitable voltage amplitude or electrical property may be utilized in addition to or instead of peak-to-peak voltage amplitude.

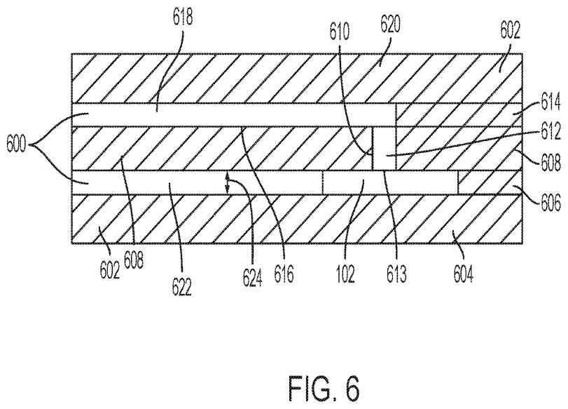

FIG. 6 is a profile view of the inductor 102, in an example embodiment. The profile view of the inductor 102 provides detailed illustration of the construction of the inductor 102 that permits the inductor 102 to flex, bend, and otherwise deform significantly more than a conventional inductor. In the illustrated example, the inductor 102 includes a conductive trace 600 formed of conductive gel seated in a substrate 602. In various examples, the substrate 602 is a flexible plastic or polymer, such as thermoplastic polyurethane (TPU),

In various examples, the substrate 602 is layered or built up to support the formation of the conductive trace 600. In such an example, the substrate 602 includes a base layer 604 and a stencil layer 606 formed on top of the base layer 604. The stencil layer 606 forms the layout of the conductive trace 600 and then the conductive trace 600 is poured or otherwise inserted into the stencil layer 606. In various examples, the conductive gel of the conductive trace 600 does not cure or otherwise solidify, and so a via layer 608 of the substrate may be applied directly the stencil layer 606 in order to retain the conductive trace 600 in place. The via layer 608 includes a through hole 610 into which the conductive trace 600 may then be poured to form a via 612 electrically coupled to a center 613 of the inductor 102. A terminal layer 614 of the substrate 602 is formed on top of the via layer 608 including a channel 616 into which the conductive trace 600 is formed to electrically couple to the via 612 to form a first terminal 618 of the inductor 102. A top layer 620 of the substrate 602 is formed on top of the terminal layer 616, enclosing the conductive trace 600 within the substrate 602. A second terminal 622 combines with the first terminal 618 to provide electrical connection over the inductor 102 as illustrated in the circuit diagram 200.

It is noted that while the layers 604, 606, 608, 614, and 620 are described as being formed separately and sequentially, the layers 604, 606, 608, 614, and 620 may be formed concurrently in whole or in part. For instance, the base layer 604 and stencil layer 606 may be formed concurrently, the via layer 608 and trace layer 614 may be formed concurrently, and the top layer 620 may be formed last. Alternatively, all of the layers 604, 606, 608, 614, and 620 may be formed simultaneously and the conductive trace 600 injected into the substrate 602. Further, while the formation of layers is discussed, the substrate 602 may be formed according to any suitable technique, including injection molding, 3D printing, and the like. In the illustrative example, the conductor 600 has a thickness 624 of approximately three hundred (300) microns.

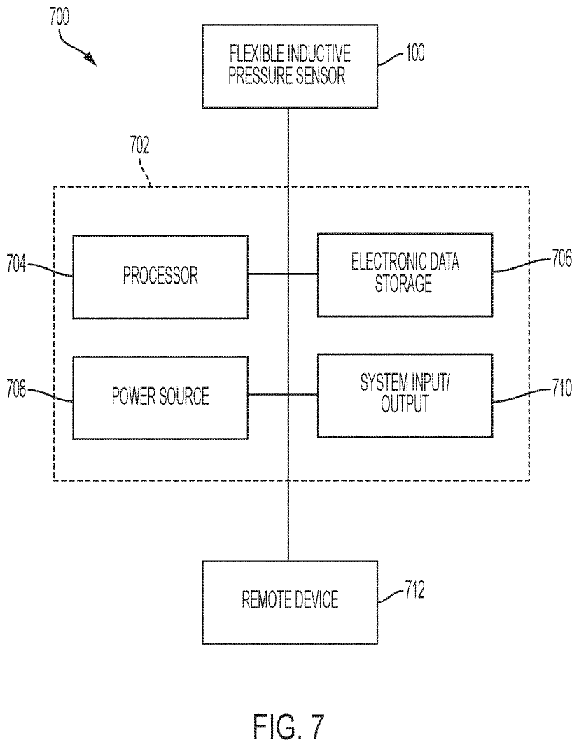

FIG. 7 is a block diagram of the flexible inductive pressure sensor 100 incorporated into a system 800, in an example embodiment. It is to be recognized and understood that the system 800 is provided for illustrative purposes and that no one component of the system is necessarily essential. Moreover, the incorporation of certain components in the system 800 may be variable with respect to certain subsystems of the system 800, and it is to be recognized and understood that certain components 800 may be incorporated as part of any subsystem or omitted altogether.

The system 800 includes one or more flexible inductive pressure sensors 100, configured in a manner suitable for use in the system 800, e.g., physical dimensions, electrical characteristics, etc. The system 800 further incorporates a control subsystem 802 operatively coupled to the flexible inductive pressure sensor 100. The control subsystem 802 includes a processor 804, an electronic data storage 806, a system power source 808, and optionally a system input/output 810 for communicating outside of the system 800. The system 800 further includes a remote device 812 that may be controlled by the control subsystem 802 based at least in part on output from the flexible inductive pressure sensor 100.

The processor 804 may be a conventional processor, microprocessor, controller, microcontroller, or any suitable processing or controlling device. The processor 804 may receive the output from the flexible electronic pressure sensor 100, e.g., a voltage output as illustrated in FIGS. 5A and SB and compare the voltage output response graph 400. The voltage output response graph 400 may be stored in and accessed from the electronic data storage 806. The electronic data storage 806 may be any one or more of a volatile or non-volatile electronic data storage, such as memory, hard drive, cache, or the like. The system power source 808 may provide power to the system 800 generally, and may be or may include the power source 208 of FIG. 2.

The remote device 812 is any device or system that may utilize information obtained on the basis of the output from the flexible inductive pressure sensor 100. In an example, the remote device 812 is a robotic clamp or hand that is configured to grip with a strength based on output from the flexible remote pressure sensor 100. Thus, in such an example, the flexible remote pressures sensor 100 may be incorporated in a wearable article such as a glove or the like or may otherwise be mounted to the finger of a wearer such that inductor 102 generally aligns with a finger pad or palm of the wearer. The user may grip an object or otherwise induce a force on flexible remote pressures sensor 100 corresponding to a desired grip strength of the remote device. Based on the output of the flexible remote pressure sensor 100 indicating force being placed on the inductor 102 and/or conductor 104, the processor 804 may translate the output of the flexible remote pressure sensor 100 to a corresponding grip strength of the remote device 812.

Additionally or alternatively, the remote device 812 may be a data output device, such as a display screen, a light or array of lights, an audio device, or the like that provides an indication of detected force on the flexible remote pressure sensor 100. In such an example, the remote device 812 may provide a measure of the force on the flexible remote pressure sensor 100 as an audio or video output. The remote device 812 may display lights or provide an audio output indicative, e.g., of the force exceeding a predetermined maximum or minimum. The above examples of the remote device 812 are provided by way of example and it is to be recognized and understood that the remote device 812 may be any device or system which may utilize the output of a pressure sensor.

The control subsystem 802 may include any additional components as desired to support the operation of the flexible inductive pressure sensor 100 and the system 800 in general. The control subsystem may include or be a part of a discrete computing device, such as a personal computer, smart phone, tablet computer, or the like and as such may include components of such a discrete computing device. In such an example, the flexible inductive pressure sensor 100 may include a wired or wireless connection to the discrete computing device. Additionally or alternatively, the control subsystem 802 may be, may include, or may access cloud computing resources or other remote computing resources. Moreover, the remote device 812 may be or may include the discrete computing device or cloud computing resources. The various components of the system 800 may be operatively coupled with respect to one another by wired or wireless technologies.

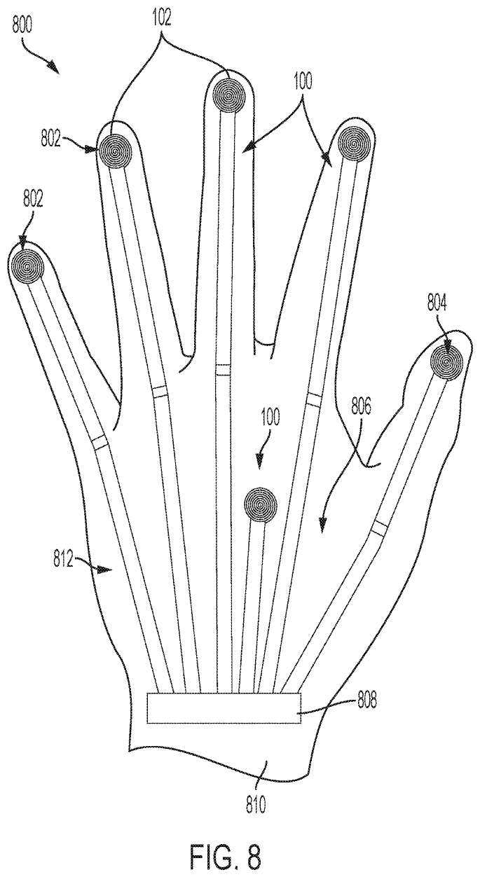

FIG. 8 is illustration of a control glove 900 that incorporates multiple flexible inductive pressure sensors 100, in an example embodiment. The control glove 900 is merely an example implementation of multiple flexible inductive pressure sensors 100, and it is to be recognized both that the flexible inductive pressure sensors 100 may be used in different numbers and configurations in a control glove and may be used outside of the context of a glove.

The control glove 900 includes one flexible inductive pressure sensor 100 having an inductor 102 and conductor 104 (not pictured) positioned to generally align with each finger pad 902 and thumb pad 904 as well as the palm 906. The flexible inductive pressure sensors 100 are secured with respect to a material of the control glove, such as a fabric, leather, or any other suitable material, by being stitched, glued, fastened, or otherwise attached according to any mechanism known in the art. The flexible cable 108 of each flexible inductive pressure sensor 100 extends to a junction 908 positioned, e.g., proximate a wrist 910 or top surface 912 of the control glove 900. In an example, the junction 908 includes sufficient connectors to receive the connectors 110 of each of the flexible inductive pressure sensors 100 simultaneously.

In one example, the junction 908 includes some or all of the components of the control subsystem 802. Alternatively, the junction 908 includes a mechanism to operatively couple with the components of the control subsystem 802, e.g., a wired or wireless output. In such an example, the control subsystem 802 is configured to receive the electronic output from each of the flexible inductive pressure sensors 100 and provide output to the remote device 812 indicative of the output from each individual flexible inductive pressure sensor 100. Thus, in such an example where the remote device 812 is a robotic hand or series of actuators, the 812 may selectively control the force of each finger or actuator on the remote device 812 according to the output of each corresponding flexible inductive pressure sensor 100.

The various components of the control glove 900 are shown for illustrative purposes, but it is to be recognized and understood that the components may in various implementations may be obscured or otherwise not visible to external inspection. Thus, for instance, the flexible inductive pressure sensors 100 may be positioned between layers of the control glove 900, e.g., between two fabric layers or on an interior surface of a single layer. Moreover, the flexible inductive pressure sensors 100 may be positioned such that inductor 102 and/or conductor 104 are on an exterior surface of the control glove 900 while the flexible cable 108 and other components are positioned on an interior surface or between fabric layers to protect those components from external forces.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

The electrically conductive compositions, such as conductive gels, comprised in the articles described herein can, for example, have a paste like or gel consistency that can be created by taking advantage of, among other things, the structure that gallium oxide can impart on the compositions when gallium oxide is mixed into a eutectic gallium alloy. When mixed into a eutectic gallium alloy, gallium oxide can form micro or nano-structures that are further described herein, which structures are capable of altering the bulk material properties of the eutectic gallium alloy.

As used herein, the term “eutectic” generally refers to a mixture of two or more phases of a composition that has the lowest melting point, and where the phases simultaneously crystallize from molten solution at this temperature. The ratio of phases to obtain a eutectic is identified by the eutectic point on a phase diagram. One of the features of eutectic alloys is their sharp melting point.

The electrically conductive compositions can be characterized as conducting shear thinning gel compositions. The electrically conductive compositions described herein can also be characterized as compositions having the properties of a Bingham plastic. For example, the electrically conductive compositions can be viscoplastics, such that they are rigid and capable of forming and maintaining three-dimensional features characterized by height and width at low stresses but flow as viscous fluids at high stress. Thus, for example, the electrically conductive compositions can have a viscosity ranging from about 10,000,000 cP to about 40,000,000 cP under low shear and about 150 to 180 at high shear. For example under condition of low shear the composition has a viscosity of about 10,000,000 cP, about 15,000,000 cP, about 20,000,000 cP, about 25,000,000 cP, about 30,000,000 cP, about 45,000,000 cP, or about 40,000,000 cP under conditions of low shear. Under condition of high shear the composition has a viscosity of about 150 cP, about 155 cP, about 160 cP, 165 cP, about 170 cP, about 175 cP, or about 180 cP.

The electrically conductive compositions described herein can have any suitable conductivity, such as a conductivity of from about 2×10⁵ S/m to about 8×10⁵ S/m.

The electrically conductive compositions described herein can have any suitable melting point, such as a melting point of from about −20° C. to about 10° C., about −10° C. to about 5° C., about −5° C. to about 5° C. or about -5° C. to about 0° C.

The electrically conductive compositions can comprise a mixture of a eutectic gallium alloy and gallium oxide, wherein the mixture of eutectic gallium alloy and gallium oxide has a weight percentage (wt %) of between about 59.9% and about 99.9% eutectic gallium alloy, such as between about 67% and about 90%, and a wt % of between about 0.1% and about 2.0% gallium oxide such as between about 0.2 and about 1%. For example, the electrically conductive compositions can have about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or greater, such as about 99.9% eutectic gallium alloy, and about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, and about 2.0% gallium oxide.

The eutectic gallium alloy can include gallium-indium or gallium-indium-tin in any ratio of elements. For example, a eutectic gallium alloy includes gallium and indium. The electrically conductive compositions can have any suitable percentage of gallium by weight in the gallium-indium alloy that is between about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

The electrically conductive compositions can have a percentage of indium by weight in the gallium-indium alloy that is between about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

The eutectic gallium alloy can include gallium and tin. For example, the electrically conductive compositions can have a percentage of tin by weight in the alloy that is between about 0.001% and about 50%, such as about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50%.

The electrically conductive compositions can comprise one or more micro-particles or sub-micron scale particles blended with the eutectic gallium alloy and gallium oxide. The particles can be suspended, either coated in eutectic gallium alloy or gallium and encapsulated in gallium oxide or not coated in the previous manner, within eutectic gallium alloy. The micro- or sub-micron scale particles can range in size from nanometer to micrometer and can be suspended in gallium, gallium-indium alloy, or gallium-indium-tin alloy. Particle to alloy ratio can vary and can change the flow properties of the electrically conductive compositions. The micro and nano-structures can be blended within the electrically conductive compositions through sonication or other suitable means. The electrically conductive compositions can include a colloidal suspension of micro and nano-structures within the eutectic gallium alloy/gallium oxide mixture.

The electrically conductive compositions can further include one or more micro-particles or sub-micron scale particles dispersed within the compositions. This can be achieved in any suitable way, including by suspending particles, either coated in eutectic gallium alloy or gallium and encapsulated in gallium oxide or not coated in the previous manner, within the electrically conductive compositions or, specifically, within the eutectic gallium alloy fluid. These particles can range in size from nanometer to micrometer and can be suspended in gallium, gallium-indium alloy, or gallium-indium-tin alloy.

Particle to alloy ratio can vary, in order to, among other things, change fluid properties of at least one of the alloy and the electrically conductive compositions. In addition, the addition of any ancillary material to colloidal suspension or eutectic gallium alloy in order to, among other things, enhance or modify its physical, electrical or thermal properties. The distribution of micro and nano-structures within the at least one of the eutectic gallium alloy and the electrically conductive compositions can be achieved through any suitable means, including sonication or other mechanical means without the addition of particles. In certain embodiments, the one or more micro-particles or sub-micron particles are blended with the at least one of the eutectic gallium alloy and the electrically conductive compositions with wt of between about 0.001% and about 40.0% of micro-particles, for example about 0.001%, about 0.005%, about 0.01%, about 0.05%, about 0.1%, about 0.2%, about 0.3%, about 0.4%, about 0.5%, about 0,6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40.

The one or more micro- or sub-micron particles can be made of any, suitable material including soda glass, silica, borosilicate glass, quartz, oxidized copper, silver coated copper, non-oxidized copper, tungsten, super saturated tin granules, glass, graphite, silver coated copper, such as silver coated copper spheres, and silver coated copper flakes, copper flakes, or copper spheres, or a combination thereof, or any other material that can be wetted by the at least one of the eutectic gallium alloy and the electrically conductive compositions. The one or more micro-particles or sub-micron scale particles can have any suitable shape, including the shape of spheroids, rods, tubes, a flakes, plates, cubes, prismatic, pyramidal, cages, and dendrimers. The one or more micro-particles or sub-micron scale particles can have any suitable size, including a size range of about 0.5 microns to about 60 microns, as about 0.5 microns, about 0.6 microns, about 0.7 microns, about 0.8 microns, about 0.9 microns, about 1 microns, about 1.5 microns, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, about 50 microns, about 51 microns, about 52 microns, about 53 microns, about 54 microns, about 55 microns, about 56 microns, about 57 microns, about 58 microns, about 59 microns, or about 60 microns.

The electrically conductive compositions described herein can be made by any suitable method, including a method comprising blending surface oxides formed on a surface of a eutectic gallium alloy into the bulk of the eutectic gallium alloy by shear mixing of the surface oxide/alloy interface. Shear mixing of such compositions can induce a cross linked microstructure in the surface oxides; thereby forming a conducting shear thinning gel composition. A colloidal suspension of micro-structures can be formed within the eutectic gallium alloy/gallium oxide mixture, for example as, gallium oxide particles and/or sheets.

The surface oxides can be blended in any suitable ratio, such as at a ratio of between about 59.9% (by weight) and about 99.9% eutectic gallium alloy, to about 0.1% (by weight) and about 2.0% gallium oxide. For example percentage by weight of gallium alloy blended with gallium oxide is about 60%, 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, or greater, such as about 99.9% eutectic gallium alloy while the weight percentage of gallium oxide is about 0.1%, about 0.2%, about 0.3%, about 0.4%, about 0.5%, about 0.6%, about 0.7%, about 0.8%, about 0.9%, about 1.0%, about 1.1%, about 1.2%, about 1.3%, about 1.4%, about 1.5%, about 1.6%, about 1.7%, about 1.8%, about 1.9%, and about 2.0% gallium oxide. In embodiments, the eutectic gallium alloy can include gallium-indium or gallium-indium-tin in any ratio of the recited elements. For example, a eutectic gallium alloy can include gallium and indium.

The weight percentage of gallium in the gallium-indium alloy can be between about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

Alternatively or in addition, the weight percentage of indium in the gallium-indium alloy can be between about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

A eutectic gallium alloy can include gallium, indium, and tin. The weight percentage of tin in the gallium-indium-tin alloy can be between about 0.001% and about 50%, such as about 0.001%, about 0.005%, about 0.01%, about 0.05%, about 0.1%, about 0.2%, about 0.3%, about 0.4%, about 0.5%, about 0.6%, about 0.7%, about 0.8% , about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 71%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50%.

The weight percentage of gallium in the gallium-indium tin alloy can be between about 40% and about 95%, such as about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, or about 95%.

Alternatively or in addition, the weight percentage of indium in the gallium-indium-tin alloy can be between about 5% and about 60%, such as about 5%, about 6%, about 7%, about 8%, about 9%, about 10%, about 11%, about 12%, about 13%, about 14%, about 15%, about 16%, about 17%, about 18%, about 19%, about 20%, about 71%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60%.

One or more micro-particles or sub-micron scale particles can be blended with the eutectic gallium alloy and gallium oxide. For example, the one or more micro-particles or sub-micron particles can be blended with the mixture with wt of between about 0.001.% and about 40.0% of micro-particles in the composition, for example about 0.001%, about 0.005%, about 0.01%, about 0.05%, about 0.1%, about 0.2%, about 0.3%, about 0.4%, about 0.5%, about 0.6%, about 0.7%, about 0.8%, about 0.9%, about 1%, about 1.5%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, or about 40. In embodiments the particles can be soda glass, silica, borosilicate glass, quartz, oxidized copper, silver coated copper, non-oxidized copper, tungsten, super saturated tin granules, glass, graphite, silver coated copper, such as silver coated copper spheres, and silver coated copper flakes, copper flakes or copper spheres or a combination thereof, or any other material that can be wetted by gallium. In some embodiments the one or more micro-particles or sub-micron scale particles are in the shape of spheroids, rods, tubes, a flakes, plates, cubes, prismatic, pyramidal, cages, and dendrimers. In certain embodiments, the one or more micro-particles or sub-micron scale particles are in the size range of about 0.5 microns to about 60 microns, as about 0.5 microns, about 0.6 microns, about 0.7 microns, about 0.8 microns, about 0.9 microns, about 1 microns, about 1.5 microns, about 2 microns, about 3 microns, about 4 microns, about 5 microns, about 6 microns, about 7 microns, about 8 microns, about 9 microns, about 10 microns, about 11 microns, about 12 microns, about 13 microns, about 14 microns, about 15 microns, about 16 microns, about 17 microns, about 18 microns, about 19 microns, about 20 microns, about 21 microns, about 22 microns, about 23 microns, about 24 microns, about 25 microns, about 26 microns, about 27 microns, about 28 microns, about 29 microns, about 30 microns, about 31 microns, about 32 microns, about 33 microns, about 34 microns, about 35 microns, about 36 microns, about 37 microns, about 38 microns, about 39 microns, about 40 microns, about 41 microns, about 42 microns, about 43 microns, about 44 microns, about 45 microns, about 46 microns, about 47 microns, about 48 microns, about 49 microns, about 50 microns, about 51 microns, about 52 microns, about 53 microns, about 54 microns, about 55 microns, about 56 microns, about 57 microns, about 58 microns, about 59 microns, or about 60 microns.

### EXAMPLES

Example 1 is a wearable article, comprising: a material configured to wear adjacent to a portion of a body part of a wearer; a flexible inductive pressure sensor secured with respect to the material, comprising: an inductor configured to deform in multiple dimensions while maintaining inductive properties; a conductor spaced apart from the inductor; a spacer positioned between the inductor and the conductor, the spacer configured to maintain a distance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor; a capacitor electrically coupled to the inductor and having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state; wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

In Example 2, the subject matter of Example 1 includes, wherein the inductor is comprised of a conductive gel.

In Example 3, the subject matter of Example 2 includes, wherein the inductor is a flat inductor having a major surface.

In Example 4, the subject matter of Example 3 includes, wherein the conductor is a conductive sheet having a major surface coplanar with the major surface of the inductor.

In Example 5, the subject matter of Example 4 includes, wherein the spacer is comprised of dielectric foam.

In Example 6, the subject matter of Examples 4-5 includes, wherein material has a material major surface and wherein the major surface of the inductor is coplanar with the material major surface.

In Example 7, the subject matter of Example 6 includes, where the material forms a glove.

In Example 8, the subject matter of Example 7 includes, wherein the flexible inductive pressure sensor is secured with respect to the material such that the inductor and the conductor are positioned in proximity of a finger pad of a finger sheath of the glove.

In Example 9, the subject matter of Examples 1-8 includes, wherein the conductor is a woven textile comprising metal coated yarns.

In Example 10, the subject matter of Examples 1-9 includes, wherein the spacer comprises a foam sheet having a twenty-five percent compression pressure from about forty-eight (48) kPa to about one hundred ten (110) kPa and a thickness from about 0.635 centimeters to about 1.27 centimeters.

In Example 11, the subject matter of Examples 1-10 includes, wherein the spacer comprises a foam sheet having a twenty-five (25) percent compression pressure of about seventy (70) kPa.

Example 12 is a flexible inductive pressure sensor, comprising: an inductor configured to deform in multiple dimensions while maintaining inductive properties; a conductor spaced apart from the inductor; a spacer positioned between the inductor and the conductor, the spacer configured to maintain a distance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor; a capacitor electrically coupled to the inductor and having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state; wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

In Example 13, the subject matter of Examples 9-12 includes, wherein the inductor is comprised of a conductive gel.

In Example 14, the subject matter of Examples 10-13 includes, wherein the inductor is a flat inductor having a major surface.

In Example 15, the subject matter of Examples 11-14 includes, wherein the conductor is a conductive sheet having a major surface coplanar with the major surface of the inductor.

In Example 16, the subject matter of Examples 12-15 includes, wherein the spacer is comprised of dielectric foam.

In Example 17, the subject matter of Examples 12-16 includes, wherein the conductor is a woven textile comprising metal coated yarns.

In Example 18, wherein the spacer comprises a foam sheet having a twenty-five (25) percent compression pressure from about forty-eight (48) kPa to about one hundred ten (110) kPa and a thickness from about 0.635 centimeters to about 1.27 centimeters.

In Example 19, the subject matter of Examples 12-18 includes, wherein the spacer comprises a foam sheet having a twenty-five (25) percent compression pressure of about seventy (70) kPa psi.

Example 20 is a method of making a flexible inductive pressure sensor, comprising: securing a spacer between an inductor and the conductor, the inductor configured to deform in multiple dimensions while maintaining inductive properties; the conductor spaced apart from the inductor by the spacer, the spacer configured to maintain a distance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor; electrically coupling a capacitor to the inductor, the capacitor having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state; wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

In Example 21, the subject matter of Example 20 includes, wherein the inductor is comprised of a conductive gel.

In Example 22, the subject matter of Example 21 includes, wherein the inductor is a flat inductor having a major surface.

In Example 23, the subject matter of Example 22 includes, wherein the conductor is a conductive sheet having a major surface coplanar with the major surface of the inductor.

In Example 24, the subject matter of Example 23 includes, wherein the spacer is comprised of dielectric foam.

In Example 25, the subject matter of Examples 20-24 includes, wherein the conductor is a woven textile comprising metal coated yarns.

In Example 26, the subject matter of Examples 20-25 includes, wherein the spacer comprises a foam sheet having a twenty-five (25) percent compression pressure from about forty-eight (48) kPa to about one hundred ten (110) kPa and a thickness from about 0.635 centimeters to about 1.27 centimeters.

In Example 27, the subject matter of Examples 20-26 includes, wherein the spacer comprises a foam sheet having a twenty-five (25) percent compression pressure of about seventy (70) kPa.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement. of any of Examples 1-27.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to he associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A wearable article, comprising:
a material configured to wear adjacent to a portion of a body part of a wearer;
a flexible inductive pressure sensor secured with respect to the material, comprising:
an inductor configured to deform in multiple dimensions while maintaining inductive properties;
a conductor spaced apart from the inductor;
a spacer positioned between the inductor and the conductor, the spacer configured to maintain a distance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor;
a capacitor electrically coupled to the inductor and having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state;
wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

2. The wearable article of claim 1, wherein the inductor is comprised of a conductive gel.

3. The wearable article of claim 2, wherein the inductor is a flat inductor having a major surface.

4. The wearable article of claim 3, wherein the conductor is a conductive sheet having a major surface coplanar with the major surface of the inductor.

5. The wearable article of claim 4, wherein the spacer is comprised of dielectric foam.

6. The wearable article of claim 4, wherein material has a material major surface and wherein the major surface of the inductor is coplanar with the material major surface.

7. The wearable article of claim 6, where the material forms a glove.

8. The wearable article of claim 7, wherein the flexible inductive pressure sensor is secured with respect to the material such that the inductor and the conductor are positioned in proximity of a finger pad of a finger sheath of the glove.

9. The wearable article of claim 1, wherein the conductor is a woven textile comprising metal coated yarns.

10. The wearable article of claim 1, wherein the spacer comprises a foam sheet having a twenty-five (25) percent compression pressure from about forty-eight (48) kPa to about one hundred ten (110) kPa and a thickness from about 0.635 centimeters to about 1.27 centimeters.

11. The wearable article of claim 1, wherein the spacer comprises a foam sheet having a twenty-five (25) percent compression pressure of about seventy (70) kPa.

12. A flexible inductive pressure sensor, comprising:
an inductor configured to deform in multiple dimensions while maintaining inductive properties;
a conductor spaced apart from the inductor;
a spacer positioned between the inductor and the conductor, the spacer configured to maintain a di stance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor;
a capacitor electrically coupled to the inductor and having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state;
wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

13. The flexible inductive pressure sensor of claim 12, wherein the inductor is comprised of a conductive gel.

14. The flexible inductive pressure sensor of claim 13, wherein the inductor is a flat inductor having a major surface.

15. The flexible inductive pressure sensor of claim 14, wherein the conductor is a conductive sheet having a major surface coplanar with the major surface of the inductor.

16. The flexible inductive pressure sensor of claim 15, wherein the spacer is comprised of dielectric foam.

17. The flexible inductive pressure sensor of claim 12, wherein the conductor is a woven textile comprising metal coated yarns.

18. The flexible inductive pressure sensor of claim 12, wherein the spacer comprises a foam sheet having a twenty-five (25) percent compression pressure from about forty-eight (48) kPa to about one hundred ten (110) kPa and a thickness from about 0.635 centimeters to about 1.27 centimeters.

19. The flexible inductive pressure sensor of claim 12, wherein the spacer comprises a foam sheet having a twenty-five (25) percent compression pressure of about seventy (70) kPa.

20. A method of making a flexible inductive pressure sensor, comprising:
securing a spacer between an inductor and the conductor, the inductor configured to deform in multiple dimensions while maintaining inductive properties, the conductor spaced apart from the inductor by the spacer, the spacer configured to maintain a distance between the inductor and the conductor in a relaxed state in absence of a force on one or both of the inductor and the conductor and to compress to a compressed state based on a force applied to one or both of the inductor and the conductor, the distance between the inductor and conductor being less when then spacer is in the compressed state than in the relaxed state, wherein the inductor has an inductance that varies based on an instantaneous distance between the inductor and the conductor;
electrically coupling a capacitor to the inductor, the capacitor having a capacitance, wherein the inductor and the capacitor form a resonant circuit based on the inductance of the inductor and the capacitance of the capacitor, the resonant circuit having a first resonant frequency based on the inductance of the inductor when the spacer is in the relaxed state and a second resonant frequency different from the first resonant frequency when the spacer is in the compressed state;
wherein the resonant circuit is configured to, upon an input electrical signal applied to the flexible inductive pressure sensor, vary a voltage amplitude of an output signal based on the force applied to one or both of the inductor and the conductor and a resultant change in the impedance of the inductor.

21. The method of claim 20, wherein the inductor is comprised of a conductive gel.

22. The method of claim 21, wherein the inductor is a flat inductor having a major surface.

23. The method of claim 22, wherein the conductor is a conductive sheet having a major surface coplanar with the major surface of the inductor.

24. The method of claim 23, wherein the spacer is comprised of dielectric foam.

25. The method of claim 20, wherein the conductor is a woven textile comprising metal coated yarns.

26. The method of claim 20, wherein the spacer comprises a foam sheet having a twenty-five (25) percent compression pressure from about forty-eight (48) kPa to about one hundred ten (110) kPa and a thickness from about 0.635 centimeters to about 1.27 centimeters.

27. The method of claim 20, wherein the spacer comprises a foam sheet having a twenty-five (25) percent compression pressure of about seventy (70) kPa.
